(19) United States
(12) Patent Application Publication
(10) Pub. No.: US 2014/0111654 A1
(43) Pub. Date: Apr. 24, 2014

(54) ELECTRONIC DEVICE AND METHOD FOR MONITORING TESTING PROCEDURE

(71) Applicants: HON HAI PRECISION INDUSTRY CO., LTD., New Taipei (TW); HONG FU JIN PRECISION INDUSTRY (ShenZhen) CO., LTD., Shenzhen (CN)

(72) Inventors: TEN-CHEN HO, New Taipei (TW); YONG-SHENG YANG, Shenzhen (CN)

(21) Appl. No.: 13/940,284

(22) Filed: Jul. 12, 2013

(30) Foreign Application Priority Data
Oct. 23, 2012 (CN) 2012104050034

(51) Int. Cl. G01B 11/14; H04N 17/00

(52) U.S. Cl. CPC G01B 11/14; H04N 17/00
USPC 348/180

(57) ABSTRACT

A method for monitoring a testing procedure using an electronic device includes constructing a coordinate system, presetting test parameters, and predetermining a position on a test platform corresponding to each preset test parameter based on the coordinate system. Positions of a test object on the test platform are changed during the testing procedure. Images of the test object are acquired from an image capturing device according to the test parameters. The method monitors the testing procedure by recognizing positions of the test object in the acquired images and determines whether the recognized positions match predetermined positions. When a recognized position does not match the predetermined position, the test object is determined to be positioned on the test platform improperly, and an alert message is outputted.

### BACKGROUND

1. Technical Field

Embodiments of the present disclosure relate to test management technology, particularly to an electronic device and a method for monitoring a testing procedure using the electronic device.

2. Description of Related Art

Generally, when an object or device is tested in a lab, the object/device needs to be put on a test platform in different positions according to various parameters. During a testing procedure, positions of the object/device needs to be changed. For example, a device needs to be rotated during testing electromagnetic radiation of the device, so as to test electromagnetic radiation values of the device when the device is at different positions. However, the object/device may be placed improperly during the testing procedure, resulting in faulty test results. Thus, an improved method for monitoring a testing procedure is desired.

### BRIEF DESCRIPTION OF THE DRAWINGS

FIG. 1 is a block diagram of one embodiment of an electronic device connected to a plurality of testing apparatuses.

FIG. 2 is a block diagram of one embodiment of the electronic device including a monitoring system.

FIG. 3 is a schematic diagram of one embodiment of a first position of a test object.

FIG. 4 is a schematic diagram of one embodiment of a second position of the test object.

FIG. 5 is a schematic diagram of one embodiment of a third position of the test object.

FIG. 6 is a flowchart of one embodiment of a method for monitoring a testing procedure using the monitoring system.

### DETAILED DESCRIPTION

The disclosure, including the accompanying drawings, is illustrated by way of examples and not by way of limitation. It should be noted that references to “an” or “one” embodiment in this disclosure are not necessarily to the same embodiment, and such references mean “at least one.”

All of the processes described below may be embodied in, and fully automated via, functional code modules executed by one or more general purpose electronic devices or processors. The code modules may be stored in any type of non-transitory computer-readable medium or other storage device. Some or all of the methods may alternatively be embodied in specialized hardware. Depending on the embodiment, the non-transitory computer-readable medium may be a hard disk drive, a compact disc, a digital video disc, a tape drive, or other suitable storage medium.

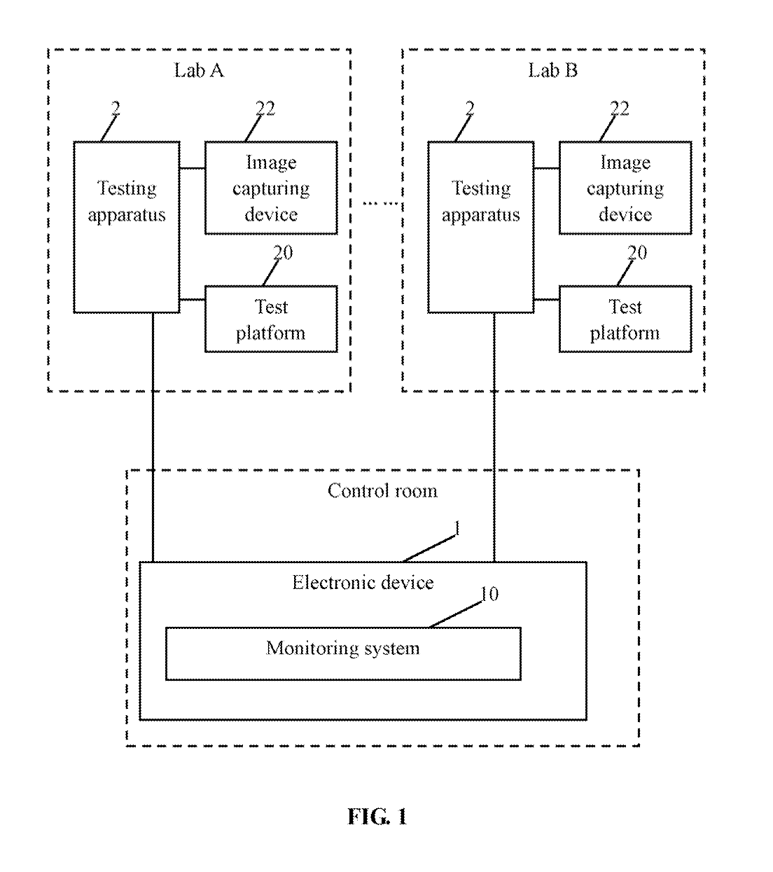

FIG. 1 is a block diagram of one embodiment of an electronic device 1 connected to a plurality of testing apparatuses 2. The electronic device 1 includes a monitoring system 10, which is used to control and monitor testing procedures of the plurality of testing apparatuses 2. Depending on the embodiment, the testing apparatuses 2 may be distributed in different labs or in the same lab to test one or more items of one or more test objects, and the electronic device 1 may be located in a control room to control the testing apparatuses 2 remotely. FIG. 1 illustrates one embodiment of the electronic device 1 and the testing apparatuses 2.

Depending on the embodiment, the electronic device 1 may be a computer, a host computer, a server, or the like. The testing apparatuses 2 may be any kind of instrument, machine, or computer to test different items of the test objects. The items may be electromagnetic radiation, voltages, power consumptions, or the like. The test objects may be electronic devices (e.g., a mobile phone, a tablet computer, a personal digital assistant) or other products.

In some embodiments, a testing apparatus 2 is connected to one or more test platforms 20 or the test platform 20 is installed on the testing apparatus 2. The test platform 20 is used to position the test objects for testing. The test platform 20 is moved or rotated according to predetermined control parameters to test the test objects at different positions or angles. For example, the test platform 20 is rotated according to a predetermined angle to test electromagnetic radiation of the test objects.

Each testing apparatus 2 is further connected to at least one image capturing device 22. The image capturing device 22 may be a camera, a webcam, or other device that can capture images or videos. In some embodiments, the image capturing device 22 captures images or videos of the test object on the test platform 20, the testing procedure, and conditions of the test objects.

The monitoring system 10 acquires captured images of the test object from one or more image capturing devices 22, determines whether the test object is located in an improper position by recognizing positions of the test object in the captured images and comparing the recognized positions with predetermined positions respectively, and outputs an alert message when the test object is located in an improper position.

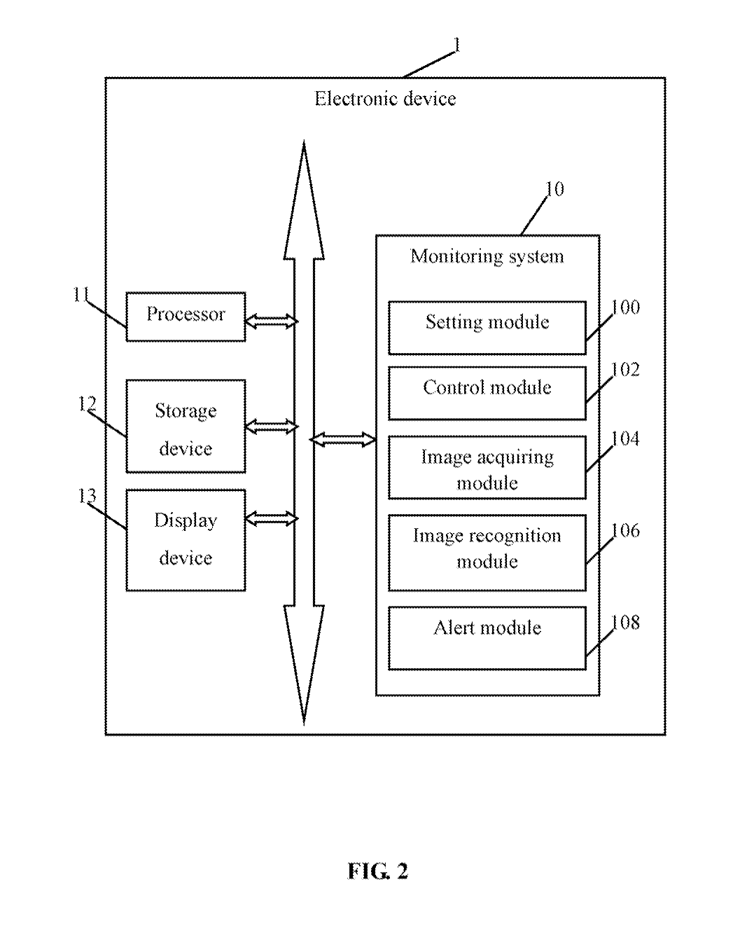

FIG. 2 is a block diagram of one embodiment of the electronic device 1 including the monitoring system 10. The electronic device 1 further includes at least one processor 11, a storage device 12, and a display device 13. FIG. 2 illustrates only one example of the electronic device 1 that may include more or fewer components than illustrated or have a different configuration of the various components.

In one embodiment, the monitoring system 10 may include computerized instructions in the form of one or more programs that are executed by the at least one processor 11 and stored in the storage device 12. The storage device 12 stores one or more programs, such as operating systems, applications of the electronic device 1, and various data such as test programs, test parameters, captured images and videos, and test results. In some embodiments, the storage device 12 may be an external storage card such as a memory stick, a smart media card, a compact flash card, a secure digital card, or any other type of memory storage device.

The display device 13 may be a liquid crystal display (LCD), a touch-sensitive display (a capacitive touch panel), or the like.

In one embodiment, the monitoring system 10 includes a setting module 100, a control module 102, an image acquiring module 104, an image recognition module 106, and an alert module 108. In general, the word “module,” as used herein, refers to logic embodied in hardware or firmware, or to a collection of software instructions written in a programming language such as Java, C, or assembly. One or more software instructions in the modules may be embedded in firmware, such as in an EPROM. The modules described herein may be implemented as software and/or hardware modules and may be stored in any type of non-transitory computer-readable medium or other storage device. Some non-limiting examples of non-transitory computer-readable medium include CDs, DVDs, BLU-RAY, flash memory, and hard disk drives.

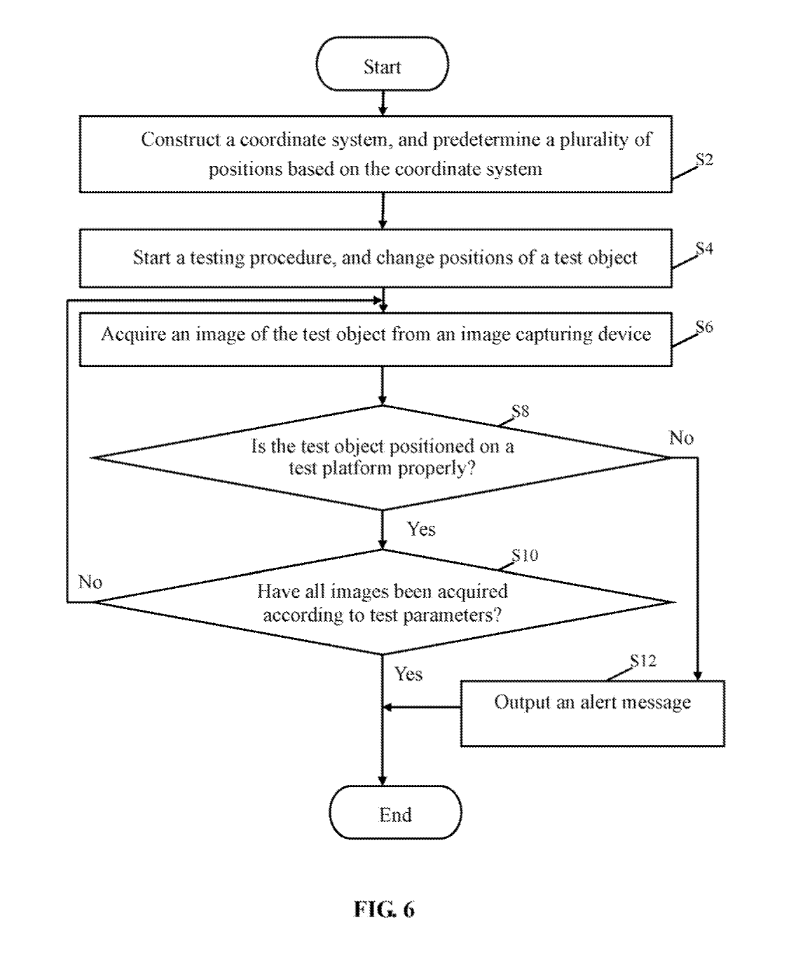

FIG. 6 is a flowchart of one embodiment of a method for monitoring a testing procedure using the monitoring system 10. Depending on the embodiment, additional steps may be added, others removed, and the ordering of the steps may be changed.

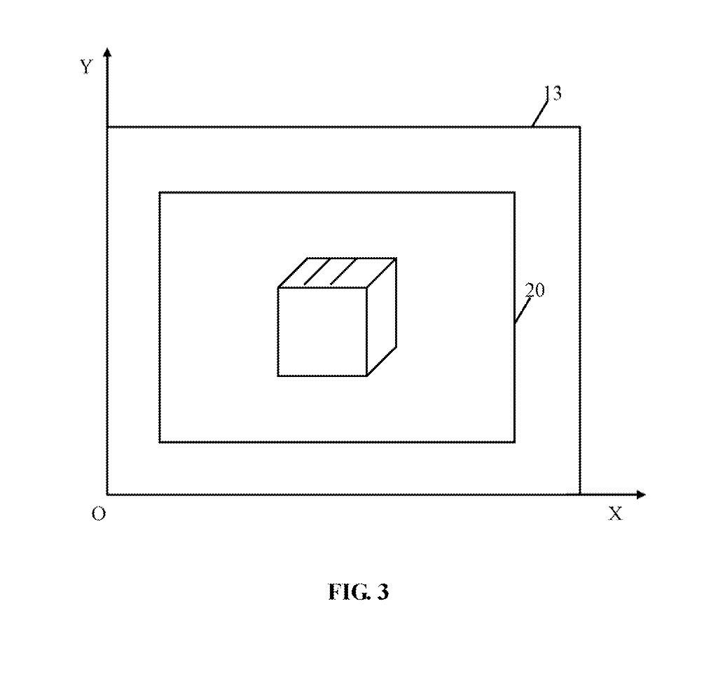

In step S2, the setting module 100 constructs a coordinate system, and predetermines a plurality of positions on the test platform 20 based on the coordinate system. FIG. 3 shows an exemplary embodiment of a coordinate system constructed based on the display device 13 of the electronic device 1. In other embodiments, an original, an X axis and a Y axis of the coordinate system may be changed according to monitoring requirements.

The predetermined positions are preset by capturing a reference image of the test platform 20 by the image capturing device 22, acquiring the reference image from the image capturing device 22, presetting a plurality of test parameters, and predetermining a position on the test platform 20 corresponding to each of the test parameters by presetting coordinates of the predetermined position on the reference image. In some embodiments, a display region on the display device 13 may be predetermined to display different kinds of images acquired from the image capturing device 22, so as to determine coordinates of different positions on the test platform 20.

In some embodiments, the test parameters may include, but are not limited to, different time points during the testing procedure and/or different angles of the test object. An angle of the test object is represented as an inclination angle between the test platform 20 and a horizontal plane, or an inclination angle between a clamp of the test platform 20 and the test platform 20. In some embodiments, the test object may be put on the test platform 20 directly or held by the clamp of the test platform 20.

One predetermined position of the test object corresponds to at least one test parameter such as a time point or an angle.

In other embodiments, the coordinate system is constructed according to pixels of the reference image.

In addition, the setting module further sets an error range for the predetermined positions, such as [−1, 1].

In step S4, the control module 102 controls a testing apparatus 2 to start testing a test object and to change the position of the test object according to predetermined control parameters by sending predetermined control commands to the testing apparatus 2 or the test platform 20. In some embodiments, the positions of the test object are changed by controlling movements or rotations of the test platform 20 or by controlling the clamp of the test platform 20 that holds the test object.

In some embodiments, the predetermined control parameters are preset by the setting module 100. The control parameters include, but are not limited to, control modes (e.g., a horizontal moving mode and a rotation mode), movement speed, movement distance, rotation angle, rotation velocity, time length, and time interval.

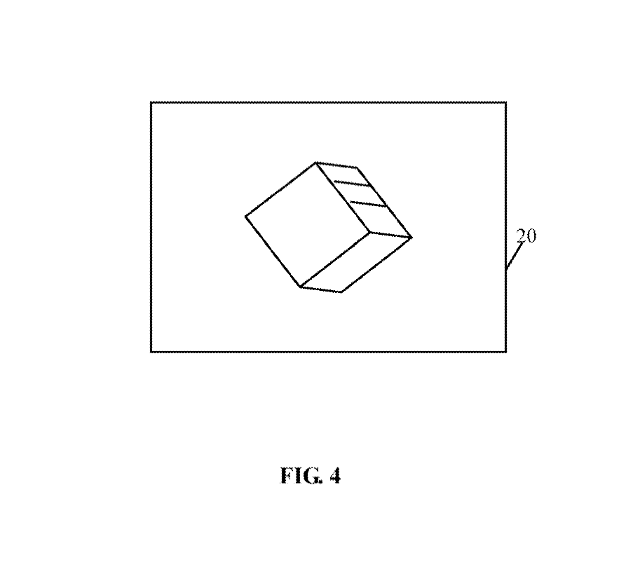

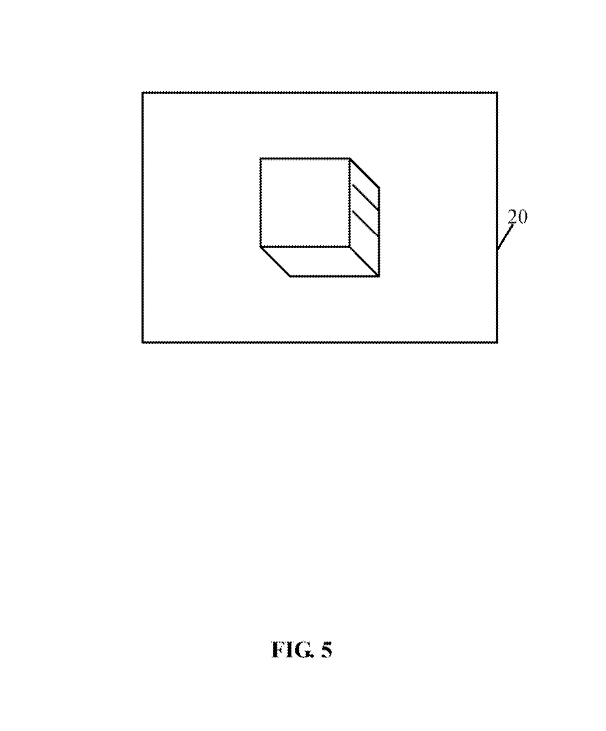

As shown in FIG. 3, FIG. 4 and FIG. 5, after the testing procedure has been started, the positions of the test object are changed by rotating the test platform 20.

In step S6, the image acquiring module 104 acquires an image of the test object from the image capturing device 22. In some embodiments, the image capturing device 22 captures a plurality of images of the test object periodically (e.g., every second), and the image acquiring module 104 acquires one or more images according to the test parameters.

In one embodiment, when the test parameters are multiple time points of the testing procedure, the image acquiring module 104 acquires a number of images corresponding to the time points at 5 seconds, 10 seconds, and 15 seconds after starting the testing procedure. In another embodiment, when the test parameters are multiple angles, the image acquiring module 104 acquires a number of images corresponding to the multiple angles. As mentioned above, the angles may be inclination angles between the test platform 20 and the horizontal plane, or inclination angles between the clamp and the test platform 20.

In other embodiments, the image capturing device 22 captures one or more videos of the testing procedure, and the image recognition module 106 analyzes the images in the videos according to the test parameters.

In step S8, the image recognition module 106 recognizes a position of the test object in the acquired image, determines the test parameter corresponding to the acquired image, and determines whether the recognized position matches a predetermined position corresponding to the determined test parameter by comparing coordinates of the recognized position with coordinates of the predetermined position.

In some embodiments, the position of the test object in the acquired image is recognized by determining coordinates of a center or vertexes of the test object. For example, if the coordinates of the center of the test object are the same as the coordinates of the predetermined position, or within the error range of the coordinates of the predetermined position, the image recognition module 106 determines that the recognized position matches the predetermined position.

When the recognized position matches the predetermined position corresponding to the determined test parameter, the image recognition module 106 determines that the test object is positioned on the test platform 20 properly and step S10 is implemented. When the recognized position does not match the predetermined position corresponding to the determined test parameter, the image recognition module 106 determines that the test object is positioned on the test platform 20 improperly, and then step S12 is implemented.

In step S12, the alert module 108 outputs an alert message on the display device 13, and the procedure ends. The alert message may be a text message shown on the display device 13 or an audio message outputted by a speaker of the electronic device 1.

In other embodiments, the image recognition module 106 determines whether or not the test object is positioned on the test platform 20 properly by implementing an image comparison method. The image comparison method acquires a plurality of image templates when a sample test object has been positioned on the test platform 20 properly according to the test parameters, compares the acquired images in step S6 with a corresponding image template, and determines whether a similarity between the acquired image and the corresponding image template is greater than or equal to a threshold value (e.g., 90%).

When the similarity is greater than or equal to the threshold value, the image recognition module 106 determines that the test object is positioned on the test platform 20 properly. Otherwise, when the similarity is less than the threshold value, the image recognition module 106 determines that the test object is positioned on the test platform 20 improperly.

In step S10, the image acquiring module 104 determines whether all images have been acquired according to the test parameters, or whether the testing procedure has ended. When all images have been acquired according to the test parameters, or the testing procedure has ended, the procedure ends. If there are any images that have not been acquired, the procedure returns to step S6. In one embodiment, the testing procedure is ended by a manual operation.

In other embodiments, the electronic device 1 is communicated with a communication device, the alert module 108 further outputs an alert signal to the communication device, and controls the communication device to call or send the alert message to a predetermined phone number. For example, the predetermined phone number may belong to an administrator.

It should be emphasized that the above-described embodiments of the present disclosure, particularly, any embodiments, are merely possible examples of implementations, set forth for a clear understanding of the principles of the disclosure. Many variations and modifications may be made to the above-described embodiment(s) of the disclosure without departing substantially from the spirit and principles of the disclosure. All such modifications and variations are intended to be included herein within the scope of this disclosure and the present disclosure is protected by the following claims.

What is claimed is:

1. A computer-implemented method for monitoring a testing procedure using an electronic device, the electronic device being connected to an image capturing device and a test platform, the method comprising:
constructing a coordinate system based on a display device of the electronic device;
capturing a reference image of the test platform from the image capturing device;
presetting a plurality of test parameters, and predetermining a position on the test platform corresponding to each of the plurality of test parameters by presetting coordinates of the predetermined position on the reference image;
changing positions of a test object on the test platform according to predetermined control parameters when the testing procedure begins;
monitoring the testing procedure, comprising:
(a) acquiring an image according to one of the test parameters from the image capturing device;
(b) recognizing a position of the test object in the acquired image, and determining a test parameter corresponding to the acquired image;
(c) determining whether the recognized position matches a predetermined position corresponding to the determined test parameter by comparing coordinates of the recognized position with coordinates of the predetermined position; and
(d) determining that the test object is positioned on the test platform properly when the recognized position matches the predetermined position corresponding to the determined test parameter, and returning to step (a) until all images have been acquired according to the plurality of test parameters or the testing procedure is ended; or
(e) determining that the test object is positioned on the test platform improperly when the recognized position does not match the predetermined position corresponding to the determined test parameter, and outputting an alert message on the display device.

2. The method according to claim 1, wherein the plurality of test parameters comprise different time points during the testing procedure, and/or different angles of the test object, the different angles of the test object are inclination angles between the test platform and a horizontal plane.

3. The method according to claim 1, wherein the positions of the test object are changed by controlling movements or rotations of the test platform, or controlling a clamp of the test platform that holds the test object.

4. The method according to claim 1, wherein the coordinate system is constructed based on the reference image.

5. The method according to claim 1, wherein the position of the test object in the acquired image is recognized by determining coordinates of a center or vertexes of the test object.

6. The method according to claim 1, wherein the electronic device communicates with a communication device, and the method further comprises:
outputting an alert signal to the communication device; and
controlling the communication device to make a phone call to a predetermined phone number or send the alert message to the predetermined phone number.

7. An electronic device being connected to an image capturing device and a test platform, the electronic device comprising:
a display device;
a storage device;
at least one processor; and
a storage device storing a plurality of instructions, which when executed by the processor, causes the at least one processor to:
construct a coordinate system based on a display device of the electronic device;
capture a reference image of the test platform from the image capturing device;
preset a plurality of test parameters, and predetermining a position on the test platform corresponding to each of the plurality of test parameters by presetting coordinates of the predetermined position on the reference image;
change positions of a test object on the test platform according to predetermined control parameters when the testing procedure begins;
monitor the testing procedure, comprising:
(a) acquire an image according to one of the test parameters from the image capturing device;
(b) recognize a position of the test object in the acquired image, and determine a test parameter corresponding to the acquired image;
(c) determine whether the recognized position matches a predetermined position corresponding to the determined test parameter by comparing coordinates of the recognized position with coordinates of the predetermined position; and
(d) determine that the test object is positioned on the test platform properly when the recognized position matches the predetermined position corresponding to the determined test parameter, and return to step (a) until all images have been acquired according to the plurality of test parameters or the testing procedure is ended; or
(e) determine that the test object is positioned on the test platform improperly when the recognized position does not match the predetermined position corresponding to the determined test parameter, and output an alert message on the display device.

8. The electronic device according to claim 7, wherein the plurality of test parameters comprise different time points during the testing procedure, and/or different angles of the test object, the different angles of the test object are inclination angles between the test platform and a horizontal plane.

9. The electronic device according to claim 7, wherein the positions of the test object are changed by controlling movements or rotations of the test platform, or controlling a clamp of the test platform that holds the test object.

10. The electronic device according to claim 7, wherein the coordinate system is constructed based on the reference image.

11. The electronic device according to claim 7, wherein the position of the test object in the acquired image is recognized by determining coordinates of a center or vertexes of the test object.

12. The electronic device according to claim 7, wherein the electronic device communicates with a communication device, and the at least one processor further:
outputs an alert signal to the communication device; and
controls the communication device to make a phone call to a predetermined phone number or send the alert message to the predetermined phone number.

13. A non-transitory storage medium having stored thereon instructions that, when executed by a processor of an electronic device, causes the electronic device to perform a method for monitoring a testing procedure using the electronic device, the electronic device being connected to an image capturing device and a test platform, the method comprising:
constructing a coordinate system based on a display device of the electronic device;
capturing a reference image of the test platform from the image capturing device;
presetting a plurality of test parameters, and predetermining a position on the test platform corresponding to each of the plurality of test parameters by presetting coordinates of the predetermined position on the reference image;
changing positions of a test object on the test platform according to predetermined control parameters when the testing procedure begins;
monitoring the testing procedure, comprising
(a) acquiring an image according to one of the test parameters from the image capturing device;
(b) recognizing a position of the test object in the acquired image, and determining a test parameter corresponding to the acquired image;
(c) determining whether the recognized position matches a predetermined position corresponding to the determined test parameter by comparing coordinates of the recognized position with coordinates of the predetermined position; and
(d) determining that the test object is positioned on the test platform properly when the recognized position matches the predetermined position corresponding to the determined test parameter, and returning to step (a) until all images have been acquired according to the plurality of test parameters or the testing procedure is ended; or
(e) determining that the test object is positioned on the test platform improperly when the recognized position does not match the predetermined position corresponding to the determined test parameter, and outputting an alert message on the display device.

14. The non-transitory storage medium according to claim 13, wherein the plurality of test parameters comprise different time points during the testing procedure, and/or different angles of the test object, the different angles of the test object are inclination angles between the test platform and a horizontal plane.

15. The non-transitory storage medium according to claim 13, wherein the positions of the test object are changed by controlling movements or rotations of the test platform, or controlling a clamp of the test platform that holds the test object.

16. The non-transitory storage medium according to claim 13, wherein the coordinate system is constructed based on the reference image.

17. The non-transitory storage medium according to claim 13, wherein the position of the test object in the acquired image is recognized by determining coordinates of a center or vertexes of the test object.

18. The non-transitory storage medium according to claim 13, wherein the electronic device communicates with a communication device, and the method further comprises:
outputting an alert signal to the communication device; and
controlling the communication device to make a phone call to a predetermined phone number or send the alert message to the predetermined phone number.
